(19) United States
(12) Patent Application Publication
(10) Pub. No.: US 2020/0258140 A1
(43) Pub. Date: Aug. 13, 2020

(54) E-ORDER GENERATION METHOD, TERMINAL AND STORAGE MEDIUM

(71) Applicant: BEIJING DAJIA INTERNET INFORMATION TECHNOLOGY CO., LTD., Beijing (CN)

(72) Inventor: Yuyang XU, Beijing (CN)

(21) Appl. No.: 16/863,276

(22) Filed: Apr. 30, 2020

(30) Foreign Application Priority Data
Apr. 30, 2019 (CN) 201910365321.4

(51) Int. Cl. G06Q 30/06; G06K 9/34; G06F 3/14; G06F 3/0488; G06K 9/00; G06F 3/0482; G10L 15/22

(52) U.S. Cl. CPC G06Q 30/0633; G06K 9/344; G06F 3/1454; G06F 16/5846; G06K 9/00711; G06F 3/0482; G10L 15/22; G06F 3/04883

(57) ABSTRACT

The present disclosure discloses an e-order generation method, a terminal, and a storage medium, and the e-order generation method includes: receiving an instruction for taking a screenshot of a broadcasting page; obtaining the screenshot of the broadcasting page; displaying an information input page in a first target area of the broadcasting page; obtaining order information based on the information input page; and sending an order generation request based on the order information and the screenshot, where the order generation request is used for requesting generation of an e-order based on the order information and the screenshot.

### CROSS-REFERENCE TO RELATED APPLICATIONS

The present application claims priority to Chinese Patent Application No. 201910365321.4, filed with the Chinese Patent Office on Apr. 30, 2019, and entitled “E-ORDER GENERATION METHOD AND APPARATUS, TERMINAL AND STORAGE MEDIUM”, which is hereby incorporated by reference in its entirety.

### FIELD

The present disclosure relates to the field of network technologies, and in particular, to an e-order generation method, a terminal and a storage medium.

### BACKGROUND

Webcast is a new form of e-commerce. In webcast of e-commerce, consumers can have a more comprehensive and intuitive understanding of commodity information. An important link of the webcast is to generate orders, so as to complete transactions between buyer users and seller users.

At present, in the traditional order generation manner of the webcast of e-commerce, a user needs to first browse through a commodity list of commodities being sold in the current live broadcast and find a desired commodity, then click a link corresponding to the commodity to enter a purchasing page of the commodity, and finally click a purchase button in the page and enter address information, the purchase quantity, and the like to generate an order. In the above process, a transaction needs a long operation path, and a user needs to perform various clicking operations step by step to generate an order, which is time-consuming and complex.

### SUMMARY

Embodiments of the present disclosure provide an e-order generation method, a terminal and a storage medium, which can solve the problem of high time consumption and operation complexity. The technical solutions are as follows.

According to an aspect, an e-order generation method is provided. The method includes:

receiving an instruction for taking a screenshot of a broadcasting page;

obtaining the screenshot of the broadcasting page;

displaying an information input page in a first target area of the broadcasting page;

obtaining order information based on the information input page; and

sending an order generation request based on the order information and the screenshot, where the order generation request is used for requesting generation of an e-order based on the order information and the screenshot.

In a possible implementation, the instruction is triggered by any one of following operations:

a screen shooting operation;

a clicking operation on a target control on the broadcasting page; or

a target gesture operation.

In a possible implementation, the target control is used to provide a function of purchasing a commodity corresponding to the broadcasting page.

In a possible implementation, after obtaining the screenshot of the broadcasting page, the method further includes any one of following:

recognizing the screenshot to obtain commodity price information contained in the screenshot; or

recognizing a video stream in target duration before a generation moment of the screenshot to obtain commodity price information indicated by the video stream.

In a possible implementation, the recognizing the screenshot to obtain commodity price information contained in the screenshot includes any one of following:

performing character recognition on a second target area of the screenshot to obtain a numeric character in the second target area, and taking the numeric character as the commodity price information;

performing character recognition on the screenshot to obtain characters included in the screenshot, and taking a numeric character, which has a target position relationship with a target character, in the screenshot as the commodity price information when the target character is included in the characters; or

performing character recognition on the screenshot to obtain characters included in the screenshot, and taking a character whose font conforms to a target font among the characters as the commodity price information.

In a possible implementation, the numeric character, which has the target position relationship with the target character, in the screenshot, is any one of following types of numeric characters:

a numeric character, having a distance being smaller than a distance threshold from the target character, in the screenshot;

a numeric character, arranged at a position in a target azimuth of the target character and having a distance being smaller than the distance threshold from the target character, in the screenshot; or

a numeric character, separated from the target character by a target symbol, in the screenshot.

In a possible implementation, before performing character recognition on the second target area of the screenshot to obtain the numeric character in the second target area, and taking the numeric character as the commodity price information, the method further includes any one of following:

taking a preset area in the screenshot as the second target area;

determining an area that is framed by a closed line with a target shape as the second target area when it is detected that the closed line is included in the screenshot; or

determining an area corresponding to a target mark as the second target area when it is detected that the target mark is included in the screenshot.

In a possible implementation, the recognizing the video stream in target duration before the generation moment of the screenshot to obtain commodity price information indicated by the video stream includes:

performing voice recognition on voice data in the video stream to obtain the commodity price information.

In a possible implementation, the performing voice recognition on voice data in the video stream to obtain the commodity price information includes any one of following:

performing voice recognition on the voice data to obtain a numeric character, and taking the numeric character as the commodity price information;

performing voice recognition on the voice data to obtain voice information, and taking a numeric character behind target information in the voice information as the commodity price information; or

performing voice recognition on the voice data, and taking a numeric character group with the number of repetition times greater than a target number of times among recognized numeric characters as the commodity price information.

In a possible implementation, the displaying the information input page in the first target area of the broadcasting page includes:

displaying the information input page that includes the commodity price information in the first target area of the broadcasting page.

In a possible implementation, the commodity price information displayed in the information input page is changeable information.

In a possible implementation, the obtaining order information based on the information input page includes:

detecting an input operation in the information input page and obtaining information input by the input operation as the order information.

In a possible implementation, after obtaining order information based on the information input page, the method further includes:

displaying a resource transfer page corresponding to the order information in the first target area of the broadcasting page; and

performing the sending the order generation request based on the order information and the screenshot when resource transfer is completed based on the resource transfer page.

In a possible implementation, the screenshot is used for determining a target commodity from a commodity list corresponding to the broadcasting page based on the screenshot.

In a possible implementation, commodity price information in the order information is used for determining a target commodity from a commodity list corresponding to the broadcasting page.

In a possible implementation, the broadcasting page includes any one of following:

a real-time video broadcasting page; or

a non-real-time video broadcasting page.

According to an aspect, a terminal is provided. The terminal includes one or more processors and one or more memories, the one or more memories store at least one instruction, and the instruction is loaded and executed by the one or more processors to implement operations of the e-order generation method.

According to an aspect, a computer readable storage medium is provided. The computer readable storage medium stores at least one instruction, and the instruction is loaded and executed by a processor to implement operations of the e-order generation method.

According to an aspect, an executable program code is provided. The executable program code is configured to be executed to perform any one of the operations of the e-order generation method.

### BRIEF DESCRIPTION OF THE DRAWINGS

To describe the technical solutions in the embodiments of the present disclosure more clearly, the accompanying drawings required for describing the embodiments will be briefly described below. Apparently, the accompanying drawings in the following description show merely some embodiments of the present disclosure, and a person of ordinary skill in the art may derive other drawings from these accompanying drawings without creative efforts.

FIG. 1 shows an implementation environment of an e-order generation method according to an embodiment of the present disclosure.

FIG. 2 is a flowchart of an e-order generation method according to an embodiment of the present disclosure.

FIG. 3 is a schematic diagram of a possible broadcasting page.

FIG. 4 is a schematic diagram of a specific form of an information input page.

FIG. 5 is a schematic diagram of a specific form of a resource transfer page.

FIG. 6 is a schematic diagram of a second target area.

FIG. 7 is a schematic diagram of another second target area.

FIG. 8 is a schematic diagram of a another second target area.

FIG. 9 is a schematic diagram of a target character.

FIG. 10 is a schematic diagram of a character of a target font.

FIG. 11 is a schematic structural diagram of an e-order generation apparatus according to an embodiment of the present disclosure.

FIG. 12 is a structural block diagram of a terminal 1200 according to an example embodiment of the present disclosure.

FIG. 13 is a schematic structural diagram of a computer device according to an embodiment of the present disclosure.

### DETAILED DESCRIPTION OF THE EMBODIMENTS

To make the objectives, technical solutions, and advantages of the present disclosure clearer, the implementations of the present disclosure will be further described in detail in conjunction with the accompanying drawings.

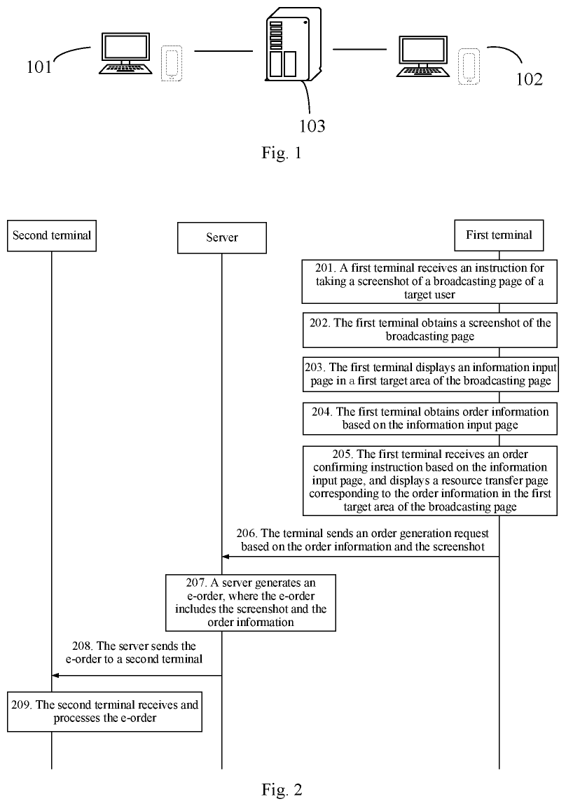

FIG. 1 shows an implementation environment of an e-order generation method according to an embodiment of the present disclosure. Referring to FIG. 1, the implementation environment includes at least one terminal 101 and at least one terminal 102. The at least one terminal 101 may be an anchor-side device and is configured to issue a live video or a made video. When issuing the live video, the terminal 101 may send a video stream to the at least one terminal 102. The at least one terminal 102 may be an audience-side device. A user watches a live broadcast based on a video stream received by the terminal 102. When issuing a made video, the terminal 101 may directly send the video to a server 103 that provides a video broadcasting service for the terminal 102. The foregoing terminal 101 may be a smartphone, a tablet computer, a portable computer and the like. The terminal 102 may be a smartphone, a tablet computer and the like. The embodiments of the disclosure do not impose limitation to this.

Certainly, the implementation environment may further include at least one server 103. The at least one server 103 may include a server for providing a video service and may further include a server for providing an e-commerce service. Certainly, the video service and the e-commerce service may be implemented by using the same server, and may also be implemented by using different servers. In an example in which the foregoing two types of services are implemented by using different servers, when a user performs video live broadcast using the terminal 101, a video stream may be issued to the first server of the at least one server 103 through the network, and the first server delivers the video stream. After receiving the video stream forwarded by the first server, the terminal 102 may broadcast based on the video stream, and interact with the second server of the at least one server 103 in the broadcasting process to perform e-commerce-related operations such as order generation and payment. After the user sends a made video to the server 103 by using the terminal 101, the server 103 may generate a video stream for the terminal 102 based on a video broadcasting request of the terminal 102, and send the video stream to the terminal 102. Then, the terminal 102 broadcasts the video.

FIG. 2 is a flowchart of an e-order generation method according to an embodiment of the present disclosure. Referring to FIG. 2, the method in this embodiment may specifically include the following steps.

201. A first terminal receives an instruction for taking a screenshot of a broadcasting page of a target user.

The broadcasting page is a page displayed by the terminal based on a received video stream. The broadcasting page may be a real-time video broadcasting page, for example, a live broadcast page, or may be a non-real-time video broadcasting page, for example, a short video broadcasting page. The instruction for taking a screenshot is used to instruct the terminal to shoot an image displayed on the display screen of the terminal. In this embodiment of the present disclosure, the instruction for taking a screenshot is further used to instruct the terminal to display an information input page for e-order generation.

In this embodiment of the present disclosure, a triggering manner of the instruction for taking a screenshot may include any one of the following possible implementations:

(1) The instruction for taking a screenshot may be triggered by a screen shooting operation. Different models of terminals may correspond to different screen shooting operations. For example, for terminals of some models, the screen shooting operation may be an operation of pressing multiple operation buttons simultaneously. For another example, for terminals of some models, the screen shooting operation may be an operation of pressing one operation button.

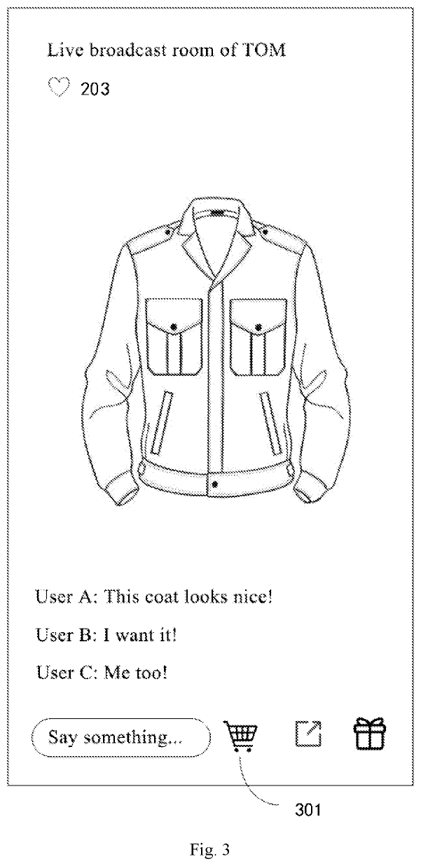

(2) The instruction for taking a screenshot may be triggered by a clicking operation on a target control on the broadcasting page. The target control may be an existing function control or a new function control on the broadcasting page. For example, the target control is used to provide a function of purchasing a commodity corresponding to the broadcasting page. When detecting a clicking operation on a target control on the broadcasting page, the terminal may trigger a screen shooting operation on the broadcasting page, to implement subsequent fast screenshot-based purchase. For example, FIG. 3 is a schematic diagram of a possible broadcasting page, and the schematic diagram of the broadcasting page includes elements such as a video picture, video information, bullet screen interaction information, and a function button, among which a shopping cart control 301 is a target control that can provide a purchase function.

(3) The instruction for taking a screenshot may be triggered by a target gesture operation detected by the terminal. The target gesture operation may be any gesture operation, and may be either a default gesture operation of an application or a user-defined gesture operation. For example, the target gesture operation may be a sliding operation with a target motion trail on the broadcasting page. When detecting a sliding operation whose motion trail conforms to the target motion trail, the terminal triggers the instruction for taking a screenshot. The target motion trail may be a triangular trail or the like, and this embodiment of the present disclosure does not impose limitation to this.

202. The first terminal obtains a screenshot of the broadcasting page.

The first terminal may invoke the screen shooting function of an operating system to take a screenshot of the currently displayed broadcasting page. For example, the screenshot of a broadcasting page on which a commodity is being introduced in a live broadcast manner may include the introduced commodity. Therefore, the screenshot can be used as a carrier of determining the commodity, and a seller can determine a target commodity from a commodity list corresponding to the broadcasting page based on the screenshot, namely, the commodity to be purchased by the user.

203. The first terminal displays an information input page in a first target area of the broadcasting page.

After receiving the instruction for taking a screenshot, the first terminal may be further triggered to display an information input page in the broadcasting page, so that the user can input remarks (such as the size and the commodity name), the receiving address and the like.

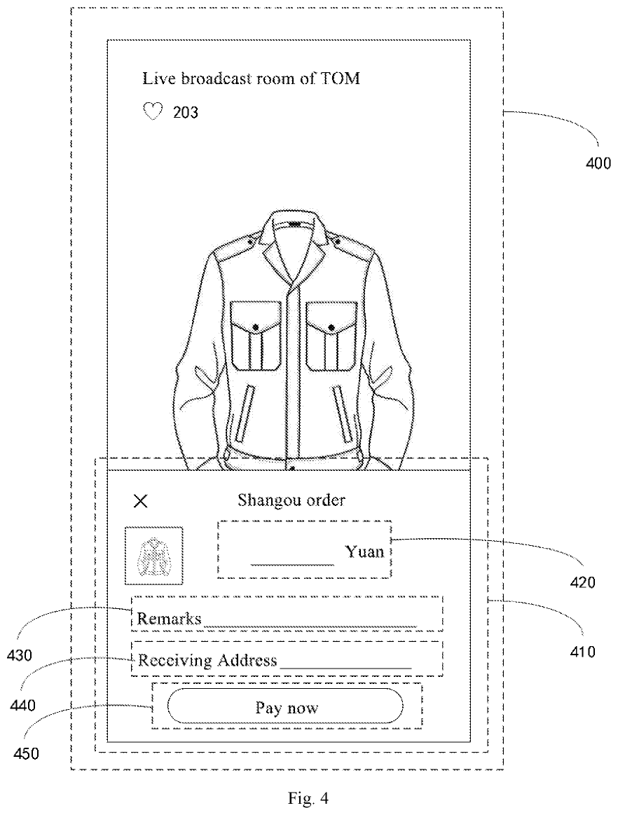

The first target area may be any area of the broadcasting page. For example, FIG. 4 is a schematic diagram of a specific form of an information input page, that the first target area is an area at the lower part of the broadcasting page 400 is used as an example, and the broadcasting page 400 includes an information input page 410. The information input page 410 may include a confirm button 450 and information input areas, such as a commodity price area 420, a remark area 430 and a receiving address area 440. In a possible implementation, when the confirm button is clicked, generation and displaying of a resource transfer page may be triggered. Of course, in another possible implementation, when the confirm button is clicked, the first terminal may be triggered to send an order generation request to a server, so as to display a resource transfer page after an e-order is generated. A next step corresponding to the confirm button is not specifically limited in the embodiment of the present disclosure.

The commodity price information is used to determine the target commodity from the commodity list corresponding to the broadcasting page, the broadcasting page does not need to provide information such as a commodity link, and the first terminal only needs to provide the commodity price information to the server or a second terminal. Then, a target user logging in to the server or second terminal can find the target commodity he/she wants to purchase by himself/herself based on commodity price information.

In the foregoing display manner, the information input page is displayed in the first target area of the broadcasting page in the scenario of not skipping to any other page. Therefore, page switching is avoided when a user enters related information, and the user can enter information while continuing watching live broadcast, which ensures the continuity of live broadcast watching.

204. The first terminal obtains order information based on the information input page.

In this embodiment of the present disclosure, when detecting information input by the user on the information input page, the first terminal obtains the input information as the order information.

205. The first terminal receives an order confirming instruction based on the information input page, and displays a resource transfer page corresponding to the order information in the first target area of the broadcasting page.

In a possible implementation, the order confirming instruction is used to trigger the displaying of the resource transfer page. In another possible implementation, the order confirming instruction is used to trigger the submission of the order information and the screenshot.

For each piece of information in the order information, mandatory information or optional information may be set, thereby ensuring that the user is prompted to provide enough information to complete the entire transaction, avoiding transaction failure caused by insufficient information, and improving the transaction efficiency. When receiving an order confirming instruction triggered based on the confirm button on the information input page, the first terminal detects whether the input information is included in a mandatory area of the information input page; if not, the first terminal does not perform the step of displaying the resource transfer page, but displays a prompt message in the mandatory area, where the prompt message is used to prompt the user to input information into the mandatory area; and if so, step 205 is performed. For example, if the first terminal fails to recognize input information in the commodity price area and the receiving address area of the information input page or if the first terminal detects that the format of input information is incorrect, the first terminal does not perform the step of displaying the resource transfer page and prompts the user to input the information correctly.

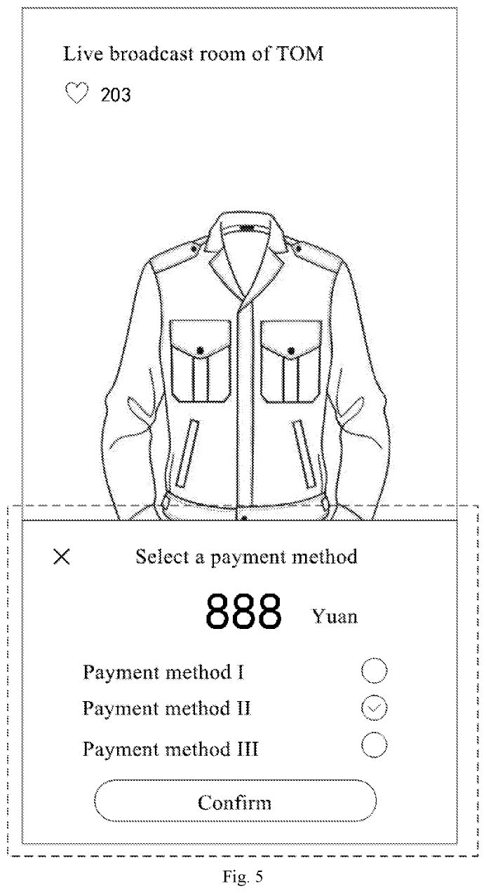

The resource transfer page may be obtained based on an interaction process of the first terminal and the server, and can be used to instruct transferring of resources equivalent to the commodity price information to the account of the target user. It should be noted that, according to an implementation in this embodiment of the present disclosure, after the order information is obtained, the resource transfer page may be directly displayed based on order determination. Alternatively, after the order information is obtained, the order information is submitted to the server first, and then the resource transfer page is displayed after the server generates an e-order. The specific process is not limited in the embodiments of the present disclosure. The foregoing resource transfer page is also an order payment page corresponding to the order information. For example, FIG. 5 is a schematic diagram of a specific form of a resource transfer page. The user can make payment by jumping to any third-party payment platform or make payment from an account of the current platform.

206. When resource transfer is completed based on the resource transfer page, the terminal sends an order generation request based on the order information and the screenshot.

In a possible implementation, the order generation request may further include user information of a user logging in to the first terminal and the like, so that the anchor user of the second terminal can communicate with the user of the first terminal based on the user information.

207. After receiving the order generation request, a server generates an e-order, where the e-order includes the screenshot and the order information.

In a possible implementation, the e-order may further include the user information of the user logging in to the first terminal and the like, so that the anchor user of the second terminal can communicate with the user of the first terminal based on the user information.

208. The server sends the e-order to the second terminal.

209. The second terminal receives and processes the e-order.

The second terminal may determine a commodity matched with the commodity price information from a commodity list according to the commodity price information carried in the e-order, and check the commodity based on the screenshot; and when the commodity in the screenshot is the same as the commodity corresponding to the commodity price information, the second terminal may take the commodity as the target commodity, and generate a delivery order based on the target commodity, thereby improving the processing efficiency and processing intelligence. Of course, the specific matching and checking processes may also be determined by the anchor user, and this embodiment of the present disclosure does not impose limitation to this.

It should be noted that, in a possible implementation, when receiving the order generation request, the server may further query a commodity list corresponding to the target user based on the commodity price information in the order information, obtain a commodity matched with the commodity price information from the commodity list, and check the commodity based on the screenshot; and when the commodity in the screenshot is the same as the commodity corresponding to the commodity price information, the server may take the commodity as the target commodity, generate a delivery order based on the target commodity, and send the delivery order to the second terminal.

In a possible implementation, when performing resource transfer, the first terminal may directly transfer a resource to an account of the second terminal, and alternatively, the server may be used as a transfer platform, thereby improving transaction security; for example, the first terminal may transfer the resource to the account of the server first, thereby triggering the server to send the delivery order to the second terminal. After delivering the commodity based on the delivery order, the second terminal may change the state of the delivery order, for example, change the state to be delivered. When the state of the delivery order is updated to be received, the server may transfer the resource obtained in the resource transfer process to the account of the target user, thereby implementing a complete transaction process. In this process, the server is used as an intermediate platform to maintain the commodity transaction state and resource transfer between a seller and a buyer, thereby greatly improving the security.

It may be learned from the foregoing e-order generation process that, compared with e-order generation solutions in related technologies, in the solutions provided by the embodiment of the present disclosure, a user can trigger a terminal to perform an order generation process of a commodity corresponding to the current broadcasting page by simple operation, instead of selecting a commodity that he/she wants to purchase from a commodity list as usual, therefore providing a more simplified and smoother order generation process for the user, shortening the commodity purchasing time, and improving the transaction efficiency. In addition, live watching and commodity purchasing can be performed synchronously in the order generation process, so that the user does not need to exit the broadcasting page, which ensures the purchase experience process successive and fluent.

In an embodiment of the present disclosure, the terminal may perform automatic recognition on the commodity price information, and pre-fill the recognized commodity price information into the commodity price area of the order information page, instead of inputting manually by the user, which can greatly reduce the involvement degree of the user and improve the intelligence of the entire order generation process. Specifically, the foregoing automatic commodity price information recognition process may include any one of the following implementations:

In a first implementation, the terminal recognizes the obtained screenshot, to obtain the commodity price information included in the screenshot.

When recognizing the obtained screenshot, the terminal may recognize key information such as a target area, a target character and a target font in the screenshot, to obtain the commodity price information included in the screenshot. This may specifically include any one of the following manners:

(1) The terminal performs character recognition on the second target area of the screenshot to obtain a numeric character in the second target area, and takes the numeric character as the commodity price information.

The commodity price information is usually expressed in the form of a numeric character. For this reason, character recognition may be used to recognize a numeric character included in the screenshot, and the recognized numeric character is used as the commodity price information. In order to reduce the processing amount of character recognition and avoid excessive computing pressure on the terminal, the terminal may only perform character recognition on a certain area of the screenshot, which can also reduce the possibility of recognition errors. The foregoing second target area is the character recognition area, and the second target area may be a preset area, an area framed by a closed line or an area corresponding to a target mark.

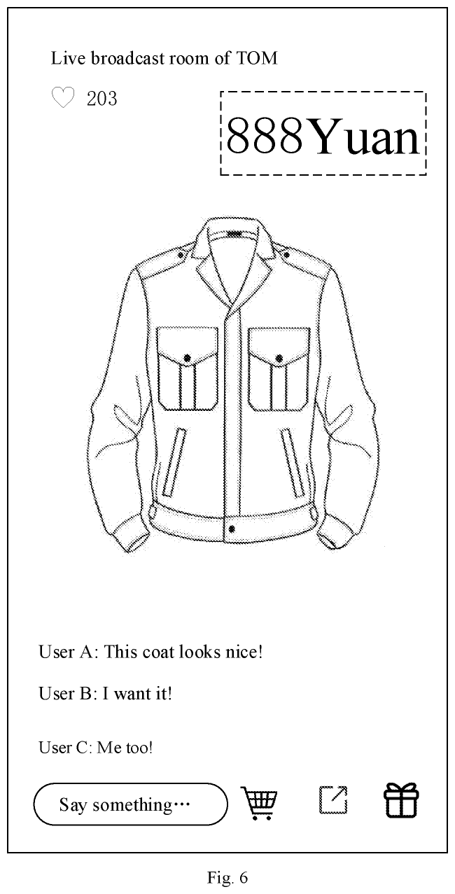

The preset area refers to a default area, and the location parameters of the preset area may be written into the application configuration file of the terminal, so that the recognition range can be limited to the preset area during character recognition. For example, referring to FIG. 6, the area framed by a dashed line is the preset area. In other words, the process of determining the second target area includes: taking the preset area as the second target area when the terminal recognizes that the preset area is included in the screenshot image.

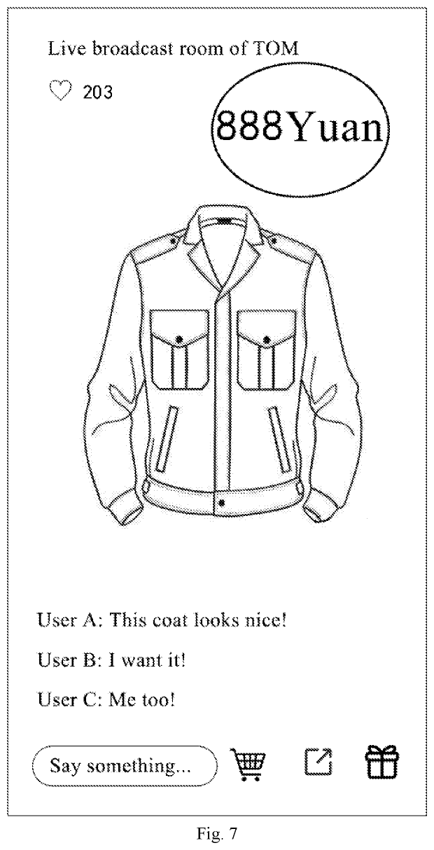

An area framed by a closed line refers to an area determined based on a target shape. The server can provide target shape options and area options for the anchor, and then, the anchor can set an area on which character recognition is to be performed, so that the commodity price information can be framed by such a closed line for display. For example, referring to FIG. 7, the area framed by an oval is the foregoing area. In other words, the process of determining the second target area includes: determining the area framed by the closed line with the target shape as the second target area when the terminal recognizes that the closed line is included in the screenshot.

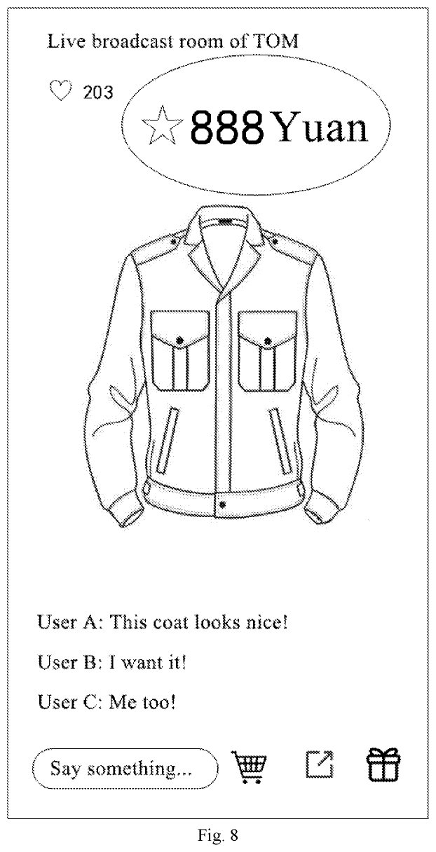

The area corresponding to the target mark refers to an area determined by taking the target mark as a central point, and the area can be of any shape. This embodiment of the present disclosure does not impose limitation to this. The target mark may be a mark preset in a program, such as keywords of commodity price and the like, a price symbol or a custom symbol. For example, referring to FIG. 8, the area corresponding to the dotted box is the foregoing area, and the area includes a star mark. In other words, the process of determining the second target area includes: determining the area corresponding to a target mark as the second target area when the terminal recognizes that the target mark is included in the screenshot.

The determining process of the second target area may be implemented by any one of the foregoing implementations. The embodiment of the present disclosure does not impose limitation to this.

(2) The terminal performs character recognition on the screenshot to obtain characters included in the screenshot, and when the characters include a target character, and takes a numeric character, which has a target position relationship with the target character, in the screenshot as commodity price information.

After obtaining characters included in the screenshot, the terminal can detect whether the recognized characters include the target character based on the target character. If the terminal detects that the recognized characters include the target character, the terminal queries, from the recognized characters based on the display position of the target character in the screenshot, a numeric character whose display position has a target position relationship with the display position of the target character to serve as the commodity price information.

It should be noted that, the foregoing numeric character querying process may include: selecting alternative numeric characters from the recognized characters, and obtaining a numeric character whose display position has a target position relationship with the display position of the target character from the alternative numeric characters. Alternatively, the foregoing numeric character querying process may include: selecting alternative characters whose display positions have a target position relationship with the display position of the target character from the recognized characters, and determining the numeric character from the alternative characters. The numeric character can be obtained by performing any of the foregoing query processes, and this embodiment of the present disclosure does not impose limitation to this.

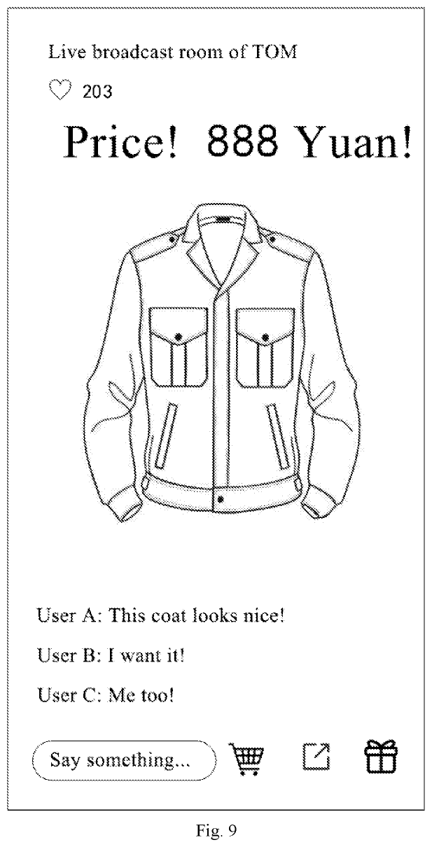

The target character may be a character that is set to indicate the position of the commodity price information, for example, the target character may be “Price”, “Bargain sale”, “¥”, “Yuan”, “$”, or the like. Which character type is specifically used may be preset, and the embodiment of the present disclosure does not impose limitation to this. For example, referring to FIG. 9, “Price” is the target character, and the commodity price information is displayed behind “Price”.

The target position relationship may be a position relationship that is between display positions and that conforms to a rule. For example, the target position relationship may specify that there is a relatively small distance between characters. Correspondingly, the target character may specifically include any one of the following types of numeric characters: 1: a numeric character, which has a distance being smaller than a distance threshold from the target character, in the screenshot; 2: a numeric character, located at a position in a target azimuth of the target character and having a distance being smaller than the distance threshold from the target character, in the screenshot; for example, the target azimuth refers to a left side, a right side, a top side, a bottom side or a preset position; or 3: a numeric character, separated from the target character by a target symbol, in the screenshot. The foregoing distance threshold and target symbol may be preset by the program.

(3) The terminal performs character recognition on the screenshot to obtain characters included in the screenshot, and takes the character whose font conforms to a target font among the characters as commodity price information.

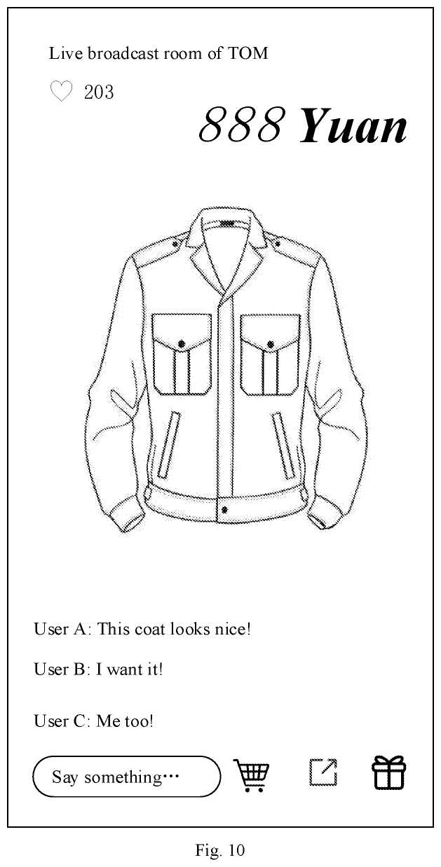

The target font may be a font preset in the program, for example, a bold font, an italic font, a certain font size, a certain color, and the like. This embodiment of the present disclosure does not impose limitation to this. Accordingly, after obtaining the characters included in the screenshot, the terminal may detect whether a character of the target font is included in the recognized characters based on the target font, and when the character of the target font is included in the recognized characters, the terminal takes the character of the target font as the commodity price information. For example, referring to FIG. 10, the font of “888” is italic of FIG. 10.

In a possible implementation, the following steps may be specifically used when performing character recognition on a target picture: first, the terminal may preprocess the obtained screenshot to reduce useless information in the screenshot, so as to facilitate subsequent feature extraction of the screenshot, where the preprocessing includes sub-steps such as graying, noise reduction, binarization, character segmentation and normalization. After the screenshot is preprocessed, the screenshot has a black color and a white color only, where the black color corresponds to the background of the screenshot, and the white color corresponds to to-be-recognized characters. Then, the terminal performs feature extraction and dimensionality reduction on the to-be-recognized characters in the white area to recognize and extract key information of the characters, the terminal classifies the characters in a classifier based on the key information of the characters, so as to generate a character classification result, and the terminal optimizes the character classification result through post-processing such as correcting the character classification result obtained by the terminal through a language model. Finally, the terminal performs character recognition based on the character classification result so as to generate a character recognition result. It should be noted that the foregoing description of character recognition is merely an exemplary introduction to a character recognition manner. This embodiment of the present disclosure does not impose limitation to a specific character recognition technology.

It should be noted that, in this embodiment of the present disclosure, numeric characters whose display position distances are smaller than a numerical distance are taken as a numeric character. For example, because distances between the display positions of the three characters of 888 are smaller than the numerical distance, 888 are recognized as a numeric character.

In a second implementation, after obtaining the screenshot of the broadcasting page, the terminal recognizes a live broadcast video stream within target duration before the generation moment of the screenshot, so as to obtain commodity price information indicated by the live broadcast video stream.

The terminal may obtain the live broadcast video stream within the target duration before the generation moment of the screenshot, perform voice recognition on voice data in the live broadcast video stream, and obtain the commodity price information based on the voice recognition result.

For live broadcast, the live broadcast video stream further includes voice data, and the voice data may contain commodity price information mentioned by the anchor who is introducing the commodity. Therefore, the commodity price information may be obtained through voice data recognition. The recognition process may include any one of the following recognition manners:

In a first recognition manner, the terminal performs voice recognition on the voice data in the live broadcast video stream, and takes a numeric character obtained by recognition as the commodity price information.

In the introduction of a commodity, the anchor side may mention the commodity price information only once to reduce the possibility of recognition errors. Therefore, if the terminal obtains a certain numeric character through voice recognition, the numeric character can be used as the commodity price information.

In a second recognition manner, the terminal performs voice recognition on the voice data to obtain voice information, and takes a numeric character behind target information in the voice information as the commodity price information.

In the voice data, target information may be taken as a prompt point of the commodity price information. After recognizing that a certain numeric character appears behind the target information in the voice information, the terminal takes the recognized numeric character as the commodity price information, where the target information may be a keyword preset in the program, for example, price, selling price, and the like.

In a third recognition manner, the terminal performs voice recognition on the voice data, and takes a numeric character group with the number of repetition times greater than the target number of times among the recognized figures as the commodity price information.

In the voice data, the number of repetition times may also be taken as a prompt point of the commodity price information. When recognizing that the number of repetition times of a certain numeric character is greater than the target number of times, the terminal takes the recognized numeric character as the commodity price information, where the target number of times may be a value preset in the program.

In a possible implementation, when performing recognition on characters in a target picture, specifically, the following steps may be used: first, the terminal processes collected target voice data to obtain the voice data containing key information; then, the terminal extracts the key information in the voice data and recognizes a word of the smallest unit based on the extracted key information; and finally, based on the key information and the word of the smallest unit, the terminal analyzes the semantic meaning of the whole sentence, fragments and rearranges key content, adjusts text composition, and modifies content with slight deviation based on the overall information, so as to generate a voice recognition result. It should be noted that the foregoing description of voice recognition manner is merely an exemplary introduction to a voice recognition manner. This embodiment of the disclosure does not impose limitation to a specific voice recognition technology.

It should be noted that, in this embodiment of the present disclosure, numeric characters whose pronunciation moment intervals are shorter than a preset interval are taken as a numeric character. For example, because intervals between the pronunciation moments of the three characters of 888 are shorter than the preset interval, 888 are recognized as a numeric character.

Based on the foregoing commodity price information obtained through recognition and the information input page, the commodity price information can be filled to the commodity price area of the information input page for display. In a possible implementation, to avoid trading errors caused by recognition errors, the commodity price information may be further set as changeable information. When commodity price information displayed in the information input page is wrong, a user can update the commodity price information to the correct commodity price information through modification without affecting the transaction. On the basis of filling price intelligently, an error correction mechanism and a more flexible handling manner are provided.

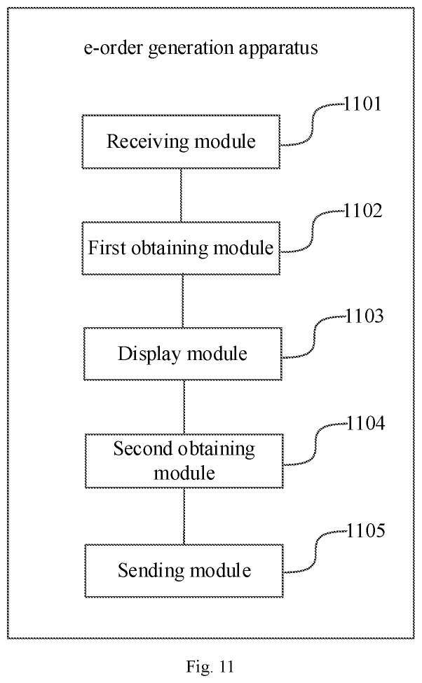

FIG. 11 is a schematic structural diagram of an e-order generation apparatus according to an embodiment of the present disclosure. Referring to FIG. 11, the apparatus includes:

a receiving module 1101, configured to receive an instruction for taking a screenshot of a broadcasting page;

a first obtaining module 1102, configured to obtain the screenshot of the broadcasting page;

a display module 1103, configured to display an information input page in a first target area of the broadcasting page;

a second obtaining module 1104, configured to obtain order information based on the information input page; and

a sending module 1105, configured to send an order generation request based on the order information and the screenshot.

In a possible implementation, the instruction is triggered by a screen shooting operation or a clicking operation on a target control on the broadcasting page.

In a possible implementation, the target control is used to provide a function of purchasing a commodity corresponding to the broadcasting page.

In a possible implementation, the apparatus further includes any one of the following modules:

a first recognition module, configured to recognize the screenshot to obtain commodity price information contained in the screenshot; or

a second recognition module, configured to recognize a live broadcast video stream in target duration before a generation moment of the screenshot to obtain commodity price information indicated by the live broadcast video stream.

In a possible implementation, the first recognition module is configured to perform any one of the following steps:

performing character recognition on a second target area of the screenshot to obtain a numeric character in the second target area, and taking the numeric character as the commodity price information;

performing character recognition on the screenshot to obtain characters included in the screenshot, and taking a numeric character, which has a target position relationship with a target character, in the screenshot as the commodity price information when the target character is included in the characters; or

performing character recognition on the screenshot to obtain characters included in the screenshot, and taking a character whose font conforms to a target font among the characters as the commodity price information.

In a possible implementation, the numeric character, which has the target position relationship with the target character, in the screenshot, is any one of the following types of numeric characters:

a numeric character, having a distance being smaller than a distance threshold from the target character, in the screenshot;

a numeric character, located at a position in a target azimuth of the target character and having a distance being smaller than the distance threshold from the target character, in the screenshot; or

a numeric character, separated from the target character by a target symbol, in the screenshot.

In a possible implementation, the first recognition module is further configured to perform any one of the following steps:

taking a preset area in the screenshot as the second target area;

determining an area that is framed by a closed line with a target shape as the second target area when it is detected that the closed line is included in the screenshot; or

determining an area corresponding to a target mark as the second target area when it is detected that the target mark is included in the screenshot.

In a possible implementation, the second recognition module is configured to: perform voice recognition on voice data in the live broadcast video stream, so as to obtain the commodity price information.

In a possible implementation, the second recognition module is configured to perform any one of the following steps:

performing voice recognition on the voice data to obtain a numeric character, and taking the numeric character as the commodity price information;

performing voice recognition on the voice data to obtain voice information, and taking a numeric character behind target information in the voice information as the commodity price information; or

performing voice recognition on the voice data, and taking a numeric character group with the number of repetition times greater than a target number of times among recognized numeric characters as the commodity price information.

In a possible implementation, the display module is configured to: display the information input page that includes the commodity price information in the first target area of the broadcasting page.

In a possible implementation, the commodity price information displayed in the information input page is changeable information.

In a possible implementation, the second obtaining module is configured to: detect an input operation in the information input page and obtain information input by the input operation as the order information.

In a possible implementation, the display module is further configured to: display a resource transfer page corresponding to the order information in the first target area of the broadcasting page; and trigger the sending module to perform the sending the order generation request based on the order information and the screenshot when resource transfer is completed based on the resource transfer page.

In a possible implementation, the screenshot is used for determining a target commodity from a commodity list corresponding to the broadcasting page based on the screenshot.

In a possible implementation, commodity price information in the order information is used for determining a target commodity from a commodity list corresponding to the broadcasting page.

In a possible implementation, the broadcasting page includes any one of following: a real-time video broadcasting page; or a non-real-time video broadcasting page.

All the foregoing optional technical solutions may be combined freely to form an optional embodiment of the present disclosure. Details are not described herein.

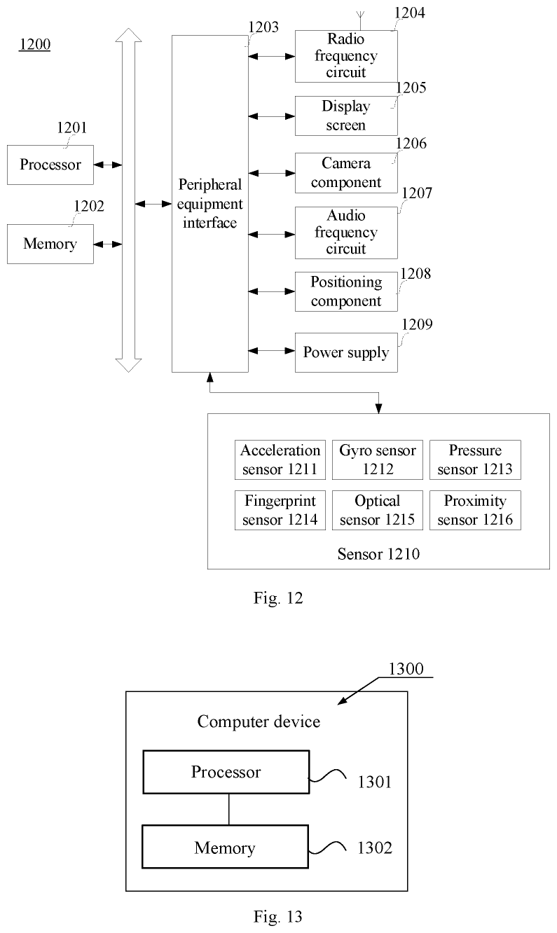

FIG. 12 is a structural block diagram of a terminal 1200 according to an example embodiment of the present disclosure. The terminal 1200 may be: a smartphone, a tablet computer, an MP3 player (Moving Picture Experts Group Audio Layer III), an MP4 (Moving Picture Experts Group Audio Layer IV) player, a laptop or a desktop computer. The terminal 1200 may also be referred to as a user device, a portable terminal, a laptop terminal, a desktop terminal, or other names.

Generally, the terminal 1200 includes a processor 1201 and a memory 1202.

The processor 1201 may include one or more processing cores. For example, the processor 1201 may be a 4-core processor, an 8-core processor or the like. The processor 1201 may be implemented by using at least one hardware form of a DSP (Digital Signal Processing), an FPGA (Field-Programmable Gate Array), and a PLA (Programmable Logic Array). The processor 1201 may also include a host processor and a co-processor. The host processor is configured to process data in an awake state, and is also referred to as a CPU (Central Processing Unit). The co-processor is a low-consumption processor configured to process data in a standby state. In some embodiments, the processor 1201 may be integrated with a GPU (Graphics Processing Unit) that is responsible for rendering and drawing content required to be displayed on the display screen. In some embodiments, the processor 1201 may further include an AI (Artificial Intelligence) processor that handles computing operations related to machine learning.

The memory 1202 may include one or more computer readable storage media. The computer readable storage media may be non-transient. The memory 1202 may further include a high-speed random access memory and a non-volatile memory, such as, one or more magnetic disk storage devices and flash memory devices. In some embodiments, the non-transient computer readable storage media in the memory 1202 are used to store at least one instruction. The at least one instruction is executed by the processor 1201 to implement the e-order generation method provided by the method embodiments of this application.

In some embodiments, the terminal 1200 may optionally include: a peripheral equipment interface 1203 and at least one peripheral. The processor 1201, the memory 1202 and the peripheral equipment interface 1203 may be connected with one another by using buses or signal cables. The peripherals may be connected to the peripheral equipment interface 1203 by using buses, signal cables, or circuit boards. Specifically, the peripheral includes at least one of a radio frequency circuit 1204, a touch display screen 1205, a camera 1206, an audio frequency circuit 1207, a positioning component 1208 and a power supply 1209.

The peripheral equipment interface 1203 may be configured to connect at least one peripheral related to Input/Output to the processor 1201 and the memory 1202. In some embodiments, the processor 1201, the memory 1202 and the peripheral equipment interface 1203 are integrated on the same chip or circuit board. In some other embodiments, any one or two of the processor 1201, the memory 1202 and the peripheral equipment interface 1203 may be implemented on an independent chip or circuit board. This embodiment does not impose limitation to this.

The radio frequency circuit 1204 is configured to receive and send an RF (Radio Frequency) signal that is also referred to as an electromagnetic signal. The radio frequency circuit 1204 communicates with a communication network and other communication devices by using the electromagnetic signal. The radio frequency circuit 1204 converts an electrical signal into an electromagnetic signal for sending, or converts a received electromagnetic signal into an electrical signal. Optionally, the radio frequency circuit 1204 includes: an antenna system, an RF transceiver, one or more amplifiers, a tuner, an oscillator, a digital signal processor, a codec chipset, a user identity module card and the like. The radio frequency circuit 1204 may communicate with another terminal through at least one wireless communication protocol. The wireless communication protocol includes but is not limited to: a metropolitan area network, a 2G, 3G, 4G or 5G mobile network, a wireless LAN and/or Wi-Fi (Wireless Fidelity) network. In some embodiments, the radio frequency circuit 1204 may further include a circuit related to NFC (Near Field Communication). This application does not impose limitation to this.

The display screen 1205 is configured to display a UI (User Interface). The UI may include a graphic, a text, an icon, a video, and any combination thereof. When the display screen 1205 is a touch display screen, the display screen 1205 further has the capability of collecting touch signals on or above the surface of the display screen 1205. The touch signal can be input to the processor 1201 as a control signal for processing. In this case, the display screen 1205 may also be used to provide a virtual button and/or a virtual keyboard that are/is also referred to as a soft button and/or a soft keyboard. In some embodiments, there may be one display screen 1205 arranged on the front panel of the terminal 1200. In some other embodiments, there may be at least two display screens 1205 that are respectively arranged on different surfaces of the terminal 1200 or arranged in a folded manner. In some other embodiments, the display screen 1205 may be a flexible display screen arranged on a curved surface or a folded surface of the terminal 1200. The display screen 1205 may even be of an irregular shape that is non-rectangular, that is, the display screen 1205 may be a special-shaped screen. The display screen 1205 may be made of an LCD (Liquid Crystal Display), an OLED (Organic Light-Emitting Diode) and the like.

The camera component 1206 is configured to collect an image or a video. Optionally, the camera component 1206 includes a front-facing camera and a rear-facing camera. Generally, the front-facing camera is arranged on the front panel of the terminal, and the rear-facing camera is arranged on the back of the terminal. In some embodiments, there are at least two rear-facing cameras that are any one of main cameras, depth-of-field cameras, wide-angle cameras or telephoto cameras, to implement a combination of a main camera and a depth-of-field camera to achieve the background blurring function, a combination of a main camera and a wide-angle camera to realize panoramic shooting and VR (Virtual Reality) shooting functions, or implement other combination shooting functions. In some embodiments, the camera component 1206 may further include a camera flash. The camera flash may be a single-color flash or may be a dual-color flash. The dual-color flash is a combination of a warm-light camera flash and a cold-light camera flash and may be used for light compensation under different color temperatures.

The audio frequency circuit 1207 may include a microphone and a speaker. The microphone is configured to collect sound waves of a user and the environment, and convert the sound waves into electrical signals, and send the electrical signals to the processor 1201 for processing, or send the sound waves to the radio frequency circuit 1204 for voice communication. For the purposes of stereo acquisition or noise reduction, there may be one or more microphones that are respectively arranged at different parts of the terminal 1200. The microphone may also be an array microphone or omnidirectional acquisition microphone. The speaker is configured to convert an electrical signal from the processor 1201 or the radio frequency circuit 1204 into a sound wave. The speaker may be a conventional thin-film speaker or a piezoelectric ceramic speaker. When the speaker is a piezoelectric ceramic speaker, the electrical signal can be converted into not only a human-audible sound wave, but also a human-inaudible sound wave for the purpose of ranging. In some embodiments, the audio circuit 1207 may also include a headphone jack.

The positioning component 1208 is configured to position the current geographic position of the terminal 1200, to implement navigation or LBS (Location Based Service). The positioning component 1208 may depend on the GPS (Global Positioning System) of the United States, the Beidou system of China, the Glonass system of Russia, or the Galileo system of the European Union.

The power supply 1209 is configured to supply power to components in the terminal 1200. The power supply 1209 may be an AC (Alternating Current) power supply, a DC (Direct Current) power supply, a non-rechargeable battery, or a rechargeable battery. When the power supply 1209 includes a rechargeable battery, the rechargeable battery may support wired or wireless charging. The rechargeable battery may further be configured to support the quick charge technology.

In some embodiments, the terminal 1200 further includes one or more sensors 1210. The one or more sensors 1210 include but are not limited to: an acceleration sensor 1211, a gyro sensor 1212, a pressure sensor 1213, a fingerprint sensor 1214, an optical sensor 1215, and a proximity sensor 1216.

The acceleration sensor 1211 may detect acceleration on the three axes of a coordinate system established by the terminal 1200. For example, the acceleration sensor 1211 may be configured to detect components of the acceleration of gravity on the three axes. The processor 1201 may control the touch display screen 1205 to display the user interface at a horizontal or vertical view angle according to gravitational acceleration signals collected by the acceleration sensor 1211. The accelerometer 1211 may further be configured to collect movement data in a game or of a user.

The gyro sensor 1212 may detect the body direction and rotation angle of the terminal 1200. The gyro sensor 1212 may work with the acceleration sensor 1211 to collect 3D actions of the user to the terminal 1200. Based on the data collected by the gyro sensor 1212, the processor 1201 can perform the following functions: motion sensing (such as changing the UI (User Interface) based on the user's tilt), image stabilization during shooting, game control, and inertial navigation.

The pressure sensor 1213 may be arranged in a side frame of the terminal 1200 and/or in the lower layer of the touch display screen 1205. When being arranged in the side frame of the terminal 1200, the pressure sensor 1213 may detect a grip signal of a user for the terminal 1200. The processor 1201 is used for left/right-handed recognition or shortcut operation based on the grip signal collected by the pressure sensor 1213. When the pressure sensor 1213 is arranged in the lower layer of the touch display screen 1205, the processor 1201 controls operable controls on the UI (User Interface) according to user's pressure operation on the touch display screen 1205. The operable controls include at least one of button controls, scroll bar controls, icon controls and menu controls.

The fingerprint sensor 1214 is configured to collect a fingerprint of a user. The processor 1201 recognizes the identity of the user according to the fingerprint collected by the fingerprint sensor 1214, or the fingerprint sensor 1214 recognizes the identity of the user according to the fingerprint collected. When the user's identity is recognized as a trusted identity, the processor 1201 authorizes the user to perform related sensitive operations, including unlocking the screen, viewing encrypted information, downloading software, paying, and changing settings. The fingerprint sensor 1214 may be arranged on the front, back or lateral side of the terminal 1200. When the terminal 1200 is equipped with a physical key or a manufacturer's logo, the fingerprint sensor 1214 may be integrated with the physical key or the manufacturer's logo.

The optical sensor 1215 is configured to collect ambient light intensity. In an embodiment, the processor 1201 may control the display brightness of the touch display screen 1205 based on the ambient light intensity collected by the optical sensor 1215. Specifically, when the ambient light intensity is relatively high, the processor 1201 turns up the brightness of the touch display screen 1205; or when the ambient light intensity is relatively low, the processor 1201 turns down the display brightness of the touch display screen 1205. In another embodiment, the processor 1201 may further dynamically adjust shooting parameters of the camera component 1206 based on the ambient light intensity collected by the optical sensor 1215.

The proximity sensor 1216 that is also referred to as a distance sensor is generally arranged on the front panel of the terminal 1200. The proximity sensor 1216 is configured to collect a distance between a user and the front side of the terminal 1200. In an embodiment, when the proximity sensor 1216 detects that the distance between the user and the front side of the terminal 1200 is becoming narrower gradually, the processor 1201 controls the touch display screen 1205 to switch to the screen-off state from the screen-on state. When the proximity sensor 1216 detects that the distance between the user and the front side of the terminal 1200 is becoming wider gradually, the processor 1201 controls the touch display screen 1205 to switch to the screen-on state from the screen-off state.

A person skilled in the art may understand that, the structure illustrated in FIG. 12 does not constitute a limitation to the terminal 1200, and may include more or less components than those illustrated in the figure, or some components may be combined, or a different component layout may be used.

FIG. 13 is a schematic structural diagram of a computer device according to an embodiment of the present disclosure. The computer device 1300 may have a relatively great difference due to difference in configuration or performance, and may include one or more processors (central processing units, CPU) 1301 and one or more memories 1302. Where the one or more memories 1302 store at least one instruction and the at least one instruction is loaded and executed by the one or more processors 1301 to implement methods provided by the foregoing method embodiments. Of course, the computer device 1300 may further include components such as a wired or wireless network interface, a keyboard, or an input/output interface, to implement input and output. The computer device 1300 may further include other components configured to implement device functions. Details are not described herein.

In an example embodiment, a computer readable storage medium, such as a memory including an instruction, is further provided. The foregoing instruction may be executed by the processor to implement the e-order generation method in the foregoing embodiment. For example, the computer readable storage medium may be a read-only memory (ROM), a random access memory (RAM), a compact disc read-only memory (CD-ROM), a magnetic tape, a floppy disk, an optical data storage device, or the like.

A person of ordinary skill in the art may understand that all or some of the steps of the embodiments may be implemented by hardware or a program instructing related hardware. The program may be stored in a computer readable storage medium. The storage medium may be a read-only memory, a magnetic disk, an optical disc, or the like.

In an example embodiment, an executable program code is further provided. The executable program code is configured to be executed to perform any one of the operations of the e-order generation method in the foregoing embodiment.

The foregoing descriptions are merely exemplary embodiments of the present disclosure, but are not intended to limit the present disclosure. Any modification, equivalent replacement, and improvement made without departing from the spirit and principle of the present disclosure shall fall within the protection scope of the present disclosure.

What is claimed is:

1. An e-order generation method, comprising:
receiving an instruction for taking a screenshot of a broadcasting page;
obtaining the screenshot of the broadcasting page;
displaying an information input page in a first target area of the broadcasting page;
obtaining order information based on the information input page; and
sending an order generation request based on the order information and the screenshot, wherein the order generation request is used for requesting generation of an e-order based on the order information and the screenshot.

2. The method according to claim 1, wherein the instruction is triggered by any one of following operations:
a screen shooting operation;
a clicking operation on a target control on the broadcasting page; or
a target gesture operation.

3. The method according to claim 2, wherein the target control is used to provide a function of purchasing a commodity corresponding to the broadcasting page.

4. The method according to claim 1, wherein after obtaining the screenshot of the broadcasting page, the method further comprises any one of following:
recognizing the screenshot to obtain commodity price information contained in the screenshot; or
recognizing a video stream in target duration before a generation moment of the screenshot to obtain commodity price information indicated by the video stream.

5. The method according to claim 4, wherein the recognizing the screenshot to obtain commodity price information contained in the screenshot comprises any one of following:
performing character recognition on a second target area of the screenshot to obtain a numeric character in the second target area, and taking the numeric character as the commodity price information;
performing character recognition on the screenshot to obtain characters comprised in the screenshot, and taking a numeric character, which has a target position relationship with a target character, in the screenshot as the commodity price information when the target character is comprised in the characters; or
performing character recognition on the screenshot to obtain characters comprised in the screenshot, and taking a character whose font conforms to a target font among the characters as the commodity price information.

6. The method according to claim 5, wherein the numeric character, which has the target position relationship with the target character, in the screenshot, is any one of following types of numeric characters:
a numeric character, having a distance being smaller than a distance threshold from the target character, in the screenshot;
a numeric character, arranged at a position in a target azimuth of the target character and having a distance being smaller than the distance threshold from the target character, in the screenshot; or
a numeric character, separated from the target character by a target symbol, in the screenshot.

7. The method according to claim 5, wherein before performing character recognition on the second target area of the screenshot to obtain the numeric character in the second target area, and taking the numeric character as the commodity price information, the method further comprises any one of following:
taking a preset area in the screenshot as the second target area;
determining an area that is framed by a closed line with a target shape as the second target area when it is detected that the closed line is comprised in the screenshot; or
determining an area corresponding to a target mark as the second target area when it is detected that the target mark is comprised in the screenshot.

8. The method according to claim 4, wherein the recognizing the video stream in target duration before the generation moment of the screenshot to obtain commodity price information indicated by the video stream comprises:
performing voice recognition on voice data in the video stream to obtain the commodity price information.

9. The method according to claim 8, wherein the performing voice recognition on voice data in the video stream to obtain the commodity price information comprises any one of following:
performing voice recognition on the voice data to obtain a numeric character, and taking the numeric character as the commodity price information;
performing voice recognition on the voice data to obtain voice information, and taking a numeric character behind target information in the voice information as the commodity price information; or
performing voice recognition on the voice data, and taking a numeric character group with the number of repetition times greater than a target number of times among recognized numeric characters as the commodity price information.

10. The method according to claim 4, wherein the displaying the information input page in the first target area of the broadcasting page comprises:
displaying the information input page that comprises the commodity price information in the first target area of the broadcasting page.

11. The method according to claim 10, wherein the commodity price information displayed in the information input page is changeable information.

12. The method according to claim 1, wherein the obtaining order information based on the information input page comprises:
detecting an input operation in the information input page and obtaining information input by the input operation as the order information.

13. The method according to claim 1, wherein after obtaining order information based on the information input page, the method further comprises:
displaying a resource transfer page corresponding to the order information in the first target area of the broadcasting page; and
performing the sending the order generation request based on the order information and the screenshot when resource transfer is completed based on the resource transfer page.

14. The method according to claim 1, wherein the screenshot is used for determining a target commodity from a commodity list corresponding to the broadcasting page based on the screenshot.

15. The method according to claim 1, wherein commodity price information in the order information is used for determining a target commodity from a commodity list corresponding to the broadcasting page.

16. The method according to claim 1, wherein the broadcasting page comprises any one of following:
a real-time video broadcasting page; or
a non-real-time video broadcasting page.

17. A terminal, comprising one or more processors and one or more memories, wherein the one or more memories store at least one instruction, the instruction is loaded and executed by the one or more processors to implement operations of the e-order generation method according to claim 1.

18. A computer readable storage medium, wherein the computer readable storage medium stores at least one instruction, and the instruction is loaded and executed by a processor to implement operations of the e-order generation method according to claim 1.

19. An executable program code, wherein the executable program code is configured to be executed to perform any one of the operations of the e-order generation method according to claim 1.
